(19) United States
(12) Patent Application Publication
(10) Pub. No.: US 2020/0119972 A1
(43) Pub. Date: Apr. 16, 2020

(54) LOG MANAGEMENT SYSTEM AND LOG MANAGEMENT METHOD

(71) Applicant: FUJITSU LIMITED, Kawasaki-shi (JP)

(72) Inventor: TOMOHIKO HIRAGUCHI, Kawasaki (JP)

(73) Assignee: FUJITSU LIMITED, Kawasaki-shi (JP)

(21) Appl. No.: 16/593,160

(22) Filed: Oct. 4, 2019

(30) Foreign Application Priority Data
Oct. 12, 2018 (JP) 2018-193314

(51) Int. Cl. H04L 12/24; H04L 29/06

(52) U.S. Cl. CPC H04L 41/069; H04L 67/28; H04L 63/1416; H04L 41/12

(57) ABSTRACT

A log management system includes one or more processors configured to, in response to a first access of a first terminal device to a first server, acquire, from the first server, a first access time of the first access and a first address used by the first terminal device for the first access, acquire, from a second server, assignment information including the one or more addresses assigned to the one or more terminal devices, one or more assignment periods for which the one or more addresses are assigned, and one or more host name of the one or more terminal devices to which the one or more addresses are assigned, identify a first host name associated with the first address and the first access time in accordance with the assignment information, and generate first log information indicating the first access associated with the first host name.

### CROSS-REFERENCE TO RELATED APPLICATION

This application is based upon and claims the benefit of priority of the prior Japanese Patent Application No. 2018-193314, filed on Oct. 12, 2018, the entire contents of which are incorporated herein by reference.

### FIELD

The embodiments discussed herein are related to a log management technology.

### BACKGROUND

For example, a monitoring device in a system monitors proxy logs of a proxy server when a client terminal communicates with external terminals via the proxy server, and in accordance with the monitoring results, the monitoring device extracts a distinctive statistic of coupling interval in communications. In accordance with the distinctive statistic, the monitoring device detects a communication with a communication partner different from usual communication partners, that is, an unauthorized communication. In this manner, the monitoring device is able to detect unauthorized communications.

Since proxy logs do not contain host names of client terminals, when it is attempted to identify a client terminal in an unauthorized communication after the unauthorized communication is detected, the search for the client terminal is carried out in accordance with a source IP address.

Related art is disclosed in, for example, Japanese Laid-open Patent Publication Nos. 2017-117255, 2003-280945, and 2017-97625.

### SUMMARY

According to an aspect of the embodiments, a log management system includes one or more processors configured to, in response to a first access of a first terminal device to a first server, acquire, from the first server, a first access time of the first access and a first address used by the first terminal device for the first access, acquire, from a second server, assignment information including the one or more addresses assigned to the one or more terminal devices, one or more assignment periods for which the one or more addresses are assigned, and one or more host name of the one or more terminal devices to which the one or more addresses are assigned, identify a first host name associated with the first address and the first access time in accordance with the assignment information, and generate first log information indicating the first access associated with the first host name.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing system of an embodiment;

FIG. 2 is a block diagram illustrating an example of a hardware configuration of a dynamic host configuration protocol (DHCP) server;

FIG. 3 is a block diagram illustrating an example of a functional configuration of the DHCP server;

FIG. 4 is a block diagram illustrating an example of a hardware configuration of an analysis server;

FIG. 5 is a block diagram illustrating an example of a functional configuration of the analysis server;

FIG. 6 illustrates an example of DHCP log information, proxy log information, assignment information, and log information;

FIG. 7 is a flowchart illustrating an example of a processing operation of a first central processing unit (CPU) in the DHCP server in relation to first generation processing;

FIG. 8 is a flowchart illustrating an example of a processing operation of a second CPU in the analysis server in relation to second generation processing; and

FIG. 9 illustrates an example of a computer that runs a log management program.

### DESCRIPTION OF EMBODIMENTS

Proxy logs usually do not contain host names that identify client terminals. Thus, for example, it is desired to involve another system and perform a search in accordance with a source IP address. In addition, it is also assumed that, after an unauthorized communication is detected, the IP address of a client terminal in the unauthorized communication is changed by means of a dynamic host configuration protocol (DHCP) server. For these reasons, it is difficult to identify the client terminal in an unauthorized communication in accordance with proxy logs by employing the related art.

Hereinafter, embodiments of a log management system or the like disclosed in the present application will be described in detail with reference to the drawings. It is noted that these embodiments do not limit the disclosed technology. The embodiments described below may be combined with each other as appropriate when there is no contradiction.

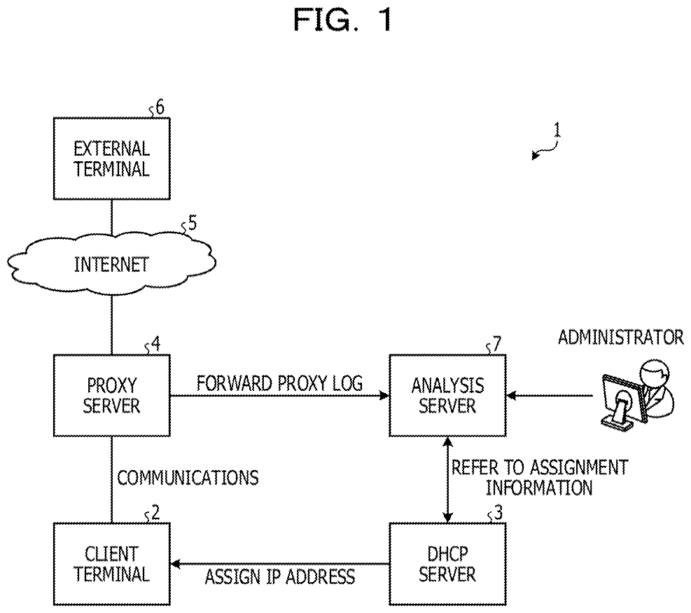

FIG. 1 illustrates an example of an information processing system 1 of an embodiment. The information processing system 1 illustrated in FIG. 1 includes a client terminal 2, a dynamic host configuration protocol (DHCP) server 3, a proxy server 4, the Internet 5, an external terminal 6, and an analysis server 7. The client terminal 2 is, for example, a communication terminal in a local area network (LAN) within a company. The proxy server 4 is an information processing apparatus, which is, for example, a first server, that mediates communications between the client terminal 2 and the Internet 5 when the client terminal 2 communicates with the external terminal 6 via the Internet 5. The DHCP server 3 is an information processing apparatus, which is, for example, a second server, that dynamically assigns to the client terminal 2 an IP address used when, for example, the client terminal 2 communicates through the Internet 5. The analysis server 7 is an information processing apparatus having a function of detecting unauthorized communications in accordance with, for example, proxy logs of the proxy server 4. The information processing system 1 is an example of the log management system.

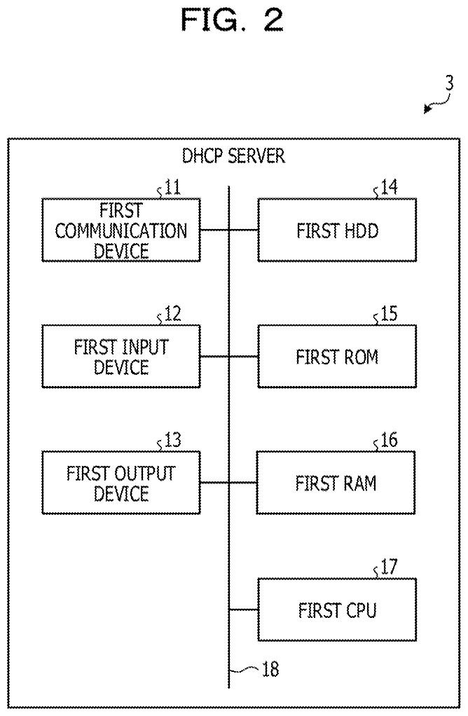

FIG. 2 is a block diagram illustrating an example of a hardware configuration of the DHCP server 3. The DHCP server 3 illustrated in FIG. 2 includes a first communication device 11, a first input device 12, a first output device 13, a first hard disk drive (HDD) 14, and a first read-only memory (ROM) 15. The DHCP server 3 also includes a first random-access memory (RAM) 16, a first central processing unit (CPU) 17, and a first bus 18. The first communication device 11 is a communication interface (IF) that communicates with, for example, the proxy server 4 and the DHCP server 3 in a corporate LAN. The first input device 12 is an input IF through which various kinds of information are input. The first output device 13 is an output IF through which various kinds of information are output. The first HDD 14 is an area in which various kinds of information are stored. The first ROM 15 is an area in which various kinds of information such as a program are stored. The first RAM 16 is an area in which various kinds of information are stored. The first CPU 17 controls the entire DHCP server 3. The first bus 18 is, for example, a transmission line coupled to the first communication device 11, the first input device 12, the first output device 13, the first HDD 14, the first ROM 15, the first RAM 16, and the first CPU 17.

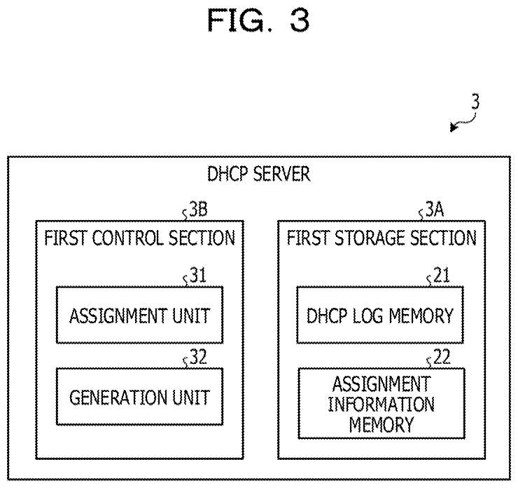

FIG. 3 is a block diagram illustrating an example of a functional configuration of the DHCP server 3. The DHCP server 3 illustrated in FIG. 3 includes a first storage section 3A and a first control section 3B. The first storage section 3A corresponds to, for example, a semiconductor memory device such as the first RAM 16 or a flash memory, or a storage device such as the first HDD 14 or an optical disk. The first storage section 3A includes DHCP log memory 21 and assignment information memory 22. The DHCP log memory 21 is an area in which DHCP log information described later is stored. The DHCP log information contains, for example, an IP address assigned by the DHCP server 3 to the client terminal 2 and a host name. The assignment information memory 22 is an area in which assignment information described later is stored. The assignment information contains, for example, an IP address and a host name that are obtained from the DHCP log information.

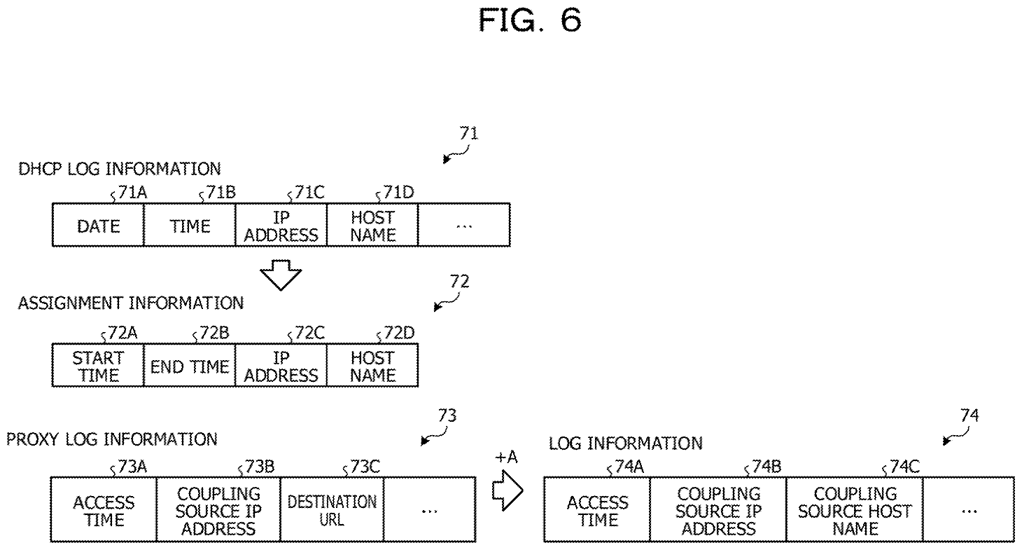

FIG. 6 illustrates an example of DHCP log information 71, assignment information 72, proxy log information 73, and log information 74. The DHCP log information 71 illustrated in FIG. 6 is log information of the DHCP server 3 in which a date 71A, a time 71B, an IP address 71C, and a host name 71D are associated with each other to manage. The DHCP log information 71 is stored in the DHCP log memory 21. The date 71A is a date on which the DHCP server 3 assigns a corresponding IP address to the client terminal 2. The time 71B is a time at which the DHCP server 3 assigns a corresponding IP address to the client terminal 2. The IP address 71C is an IP address that is assigned by the DHCP server 3 to the client terminal 2. The host name 71D is a host name that identifies the client terminal 2 to which a corresponding IP address is assigned by the DHCP server 3.

The assignment information 72 is information in which a start time 72A, an end time 72B, an IP address 72C, and a host name 72D are associated with each other to manage. The assignment information 72 is stored in the assignment information memory 22 on the DHCP server 3. The start time 72A is a start time at which the DHCP server 3 starts assigning a corresponding IP address to the client terminal 2. The end time 72B is a time at which the DHCP server 3 finishes assigning a corresponding IP address to the client terminal 2. The IP address 72C is an IP address that is assigned by the DHCP server 3 to the client terminal 2. The host name 72D is a host name of the client terminal 2 to which the DHCP server 3 assigns a corresponding IP address.

The first control section 3B corresponds to, for example, an electronic circuit such as the first CPU 17. The first control section 38 includes internal memory for storing a program in which various procedures are specified and control data and executes various kinds of processing by using the program and data. The first CPU 17 loads into, for example, the first RAM 16 the program stored in the first ROM 15. By running as processes the program loaded into the first RAM 16, the first CPU 17 functions as, for example, an assignment unit 31 and a generation unit 32. The assignment unit 31 dynamically assigns an IP address to the client terminal 2. The generation unit 32 generates assignment information from DHCP log information stored in the DHCP log memory 21.

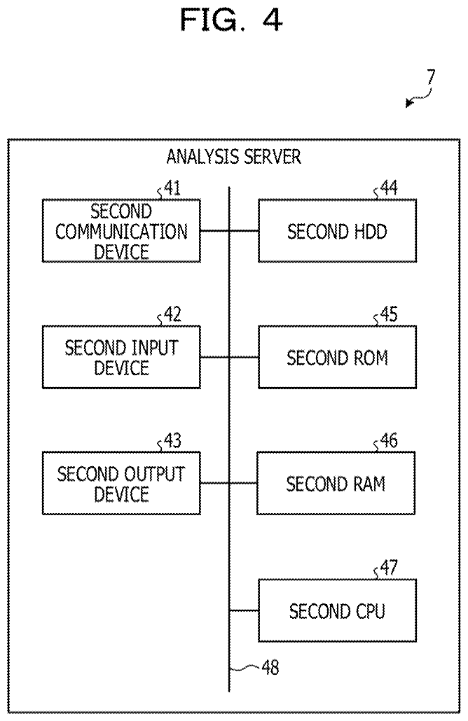

FIG. 4 is a block diagram illustrating an example of a hardware configuration of the analysis server 7. The analysis server 7 illustrated in FIG. 4 includes a second communication device 41, a second input device 42, a second output device 43, a second HDD 44, a second ROM 45, a second RAM 46, a second CPU 47, and a second bus 48. The second communication device 41 is a communication IF that establishes communication coupling with, for example, the proxy server 4 and the DHCP server 3. The second input device 42 is an input IF through which various kinds of information are input. The second output device 43 is an output IF through which various kinds of information are output. The second HDD 44 is an area in which various kinds of information are stored. The second ROM 45 is an area in which various kinds of information such as a program are stored. The second RAM 46 is an area in which various kinds of information are stored. The second CPU 47 controls the entire analysis server 7. The second bus 48 is, for example, a transmission line coupled to the second communication device 41, the second input device 42, the second output device 43, the second HDD 44, the second ROM 45, the second RAM 46, and the second CPU 47.

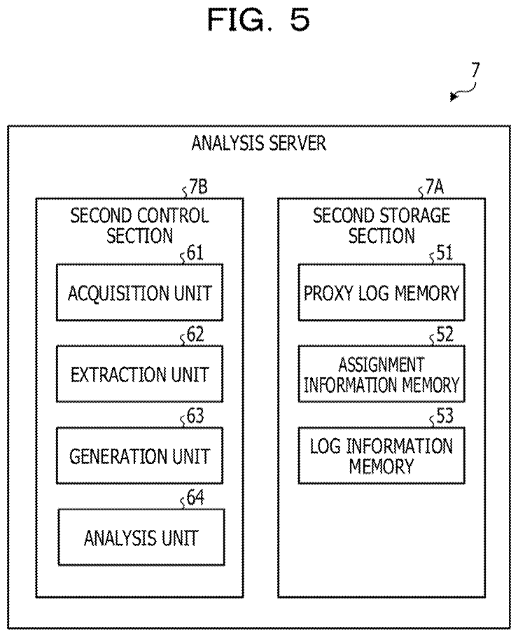

FIG. 5 is a block diagram illustrating an example of a functional configuration of the analysis server 7. The analysis server 7 illustrated in FIG. 5 includes a second storage section 7A and a second control section 7B. The second storage section 7A corresponds to, for example, a semiconductor memory device such as the second RAM 46 or a flash memory, or a storage device such as the second HDD 44 or an optical disk. The second storage section 7A includes proxy log memory 51, assignment information memory 52, and log information memory 53. The proxy log memory 51 is an area in which proxy log information described later is stored. The proxy log information is log information of the proxy server 4 obtained from the proxy server 4. The assignment information memory 52 is an area in which the assignment information described later is stored. The assignment information is obtained from the DHCP server 3. The log information memory 53 is an area in which log information described later is stored. The log information is generated by comparing the assignment information and the proxy log information.

The proxy log information 73 illustrated in FIG. 6 is log information of the proxy server 4 in which an access time 73A, a coupling source IP address 73B, and a destination Uniform Resource Locator (URL) 73C are associated with each other to manage. The proxy log information 73 is periodically obtained from the proxy server 4 and stored in the proxy log memory 51. The access time 73A is a time at which the client terminal 2 accesses the proxy server 4. The coupling source IP address 73B is an IP address of the client terminal 2 that accesses the proxy server 4. The destination URL 73C is a URL that the client terminal 2 accessing the proxy server 4 accesses.

The log information 74 illustrated in FIG. 6 is information in which an access time 74A, a coupling source IP address 74B, and a coupling source host name 74C are associated with each other to manage. The log information 74 is stored in the log information memory 53 on the analysis server 7. The access time 74A is a time at which the client terminal 2 accesses the proxy server 4. The coupling source IP address 74B is an IP address assigned to the client terminal 2 when the client terminal 2 accesses the proxy server 4. The coupling source host name 74C is a host name of the client terminal 2 that accesses the proxy server 4.

The second control section 7B corresponds to, for example, an electronic circuit such as the second CPU 47. The second control section 78 includes internal memory for storing a program in which various procedures are specified and control data and executes various kinds of processing by using the program and data. The second CPU 47 loads into, for example, the second RAM 46 the program stored in the second ROM 45. By running as processes the program loaded into the second RAM 46, the second CPU 47 functions as, for example, an acquisition unit 61, an extraction unit 62, a generation unit 63, and an analysis unit 64. The acquisition unit 61 obtains the proxy log information 73 from the proxy server 4. The acquisition unit 61 obtains, for example, once a day the proxy log information 73 collected in the proxy server 4 in a predetermined period. The extraction unit 62 refers to the assignment information 72 and extracts the host name 72D from a particular record of the assignment information 72 in which the corresponding IP address 72C is identical to the coupling source IP address 73B in the proxy log information 73 and a corresponding period for which the IP address 72C is assigned involves the access time 73A. The assignment period is a time period from the start time 72A to the end time 72B.

The generation unit 63 generates the log information 74 that is data containing at least an obtained access time and an extracted host name and stores the generated log information 74 in the log information memory 53. The analysis unit 64 refers to the log information 74 in the log information memory 53 and specifies the coupling source host name 74C corresponding to the coupling source IP address 74B identical to an IP address involved in unauthorized communication. As a result, the IP address involved in unauthorized communication is determined in accordance with a coupling source host name.

In FIG. 6, the DHCP server 3 stores the DHCP log information 71 in the DHCP log memory 21. The DHCP server 3 also generates the assignment information 72 from the DHCP log information 71 stored in the DHCP log memory 21 and stores the assignment information 72 in the assignment information memory 22. The analysis server 7 obtains the proxy log information 73 from the proxy server 4 and stores the proxy log information 73 in the proxy log memory 51. The analysis server 7 also stores in the assignment information memory 22 the assignment information 72 obtained from the DHCP server 3. The analysis server 7 generates the log information 74 in accordance with the proxy log information 73 and the assignment information 72 and stores the generated log information 74 in the log information memory 53.

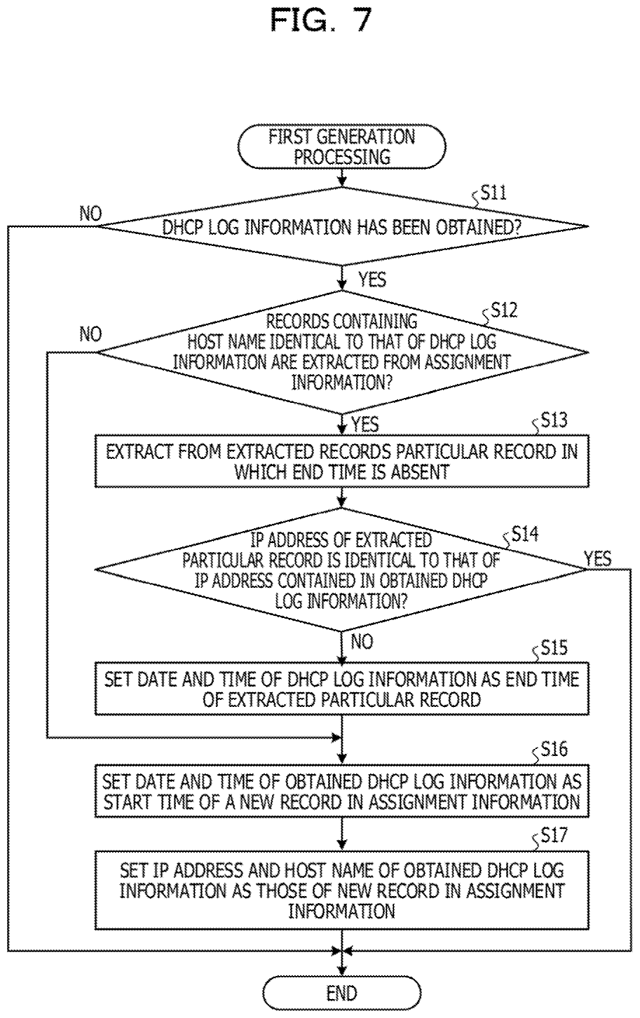

Next, an operation of the information processing system 1 of this embodiment is described. FIG. 7 is a flowchart illustrating an example of a processing operation of the first CPU 17 in the DHCP server 3 in relation to first generation processing. The generation unit 32 in the first CPU 17 determines whether the DHCP log information 71 has been obtained (step S11). When the generation unit 32 determines that the DHCP log information 71 has been obtained (Yes in step S11), the generation unit 32 extracts from the assignment information 72 records containing a host name identical to the host name contained in the obtained DHCP log information 71 (step S12).

The generation unit 32 extracts from the extracted records a particular record in which the end time 72B is absent (step S13). The generation unit 32 determines whether the IP address 72C in the extracted particular record is identical to the IP address 71C in the DHCP log information 71 obtained in step S11 (step S14). When the generation unit 32 determines that the IP addresses are not identical to each other (No in step S14), the generation unit 32 sets the date 71A and the time 71B in the obtained DHCP log information 71 as the end time 72B absent in the extracted particular record (step S15).

The generation unit 32 sets the date 71A and the time 71B in the obtained DHCP log information 71 as the start time 72A in a new record of the assignment information 72 (step S16). The generation unit 32 also sets the IP address 71C and the host name 71D in the obtained DHCP log information 71 as those of the new record that has been set in step S16 (step S17); the processing operation illustrated in FIG. 7 consequently ends.

When the generation unit 32 determines that the DHCP log information 71 has not been obtained (No in step S11), the processing operation illustrated in FIG. 7 consequently ends. When the generation unit 32 does not extract records containing an identical host name (No in step S12), the processing operation moves to step S16 to set the date 71A and the time 71B in the obtained DHCP log information 71 as the start time 72A in a new record.

When the generation unit 32 determines that the IP address 72C in the extracted particular record is identical to the IP address 71C in the DHCP log information 71 (Yes in step S14), the processing operation illustrated in FIG. 7 consequently ends.

When the assignment information does not contain a particular host name identical to a host name contained in the DHCP log information 71, the DHCP server 3 performing the first generation processing sets a new record of assignment information by using the date 71A and the time 71B, and the IP address 71C and the host name 71D contained in the DHCP log information 71. As a result, the DHCP server 3 is able to obtain assignment information in which a start time, an end time, an IP address, and a host name are associated with each other.

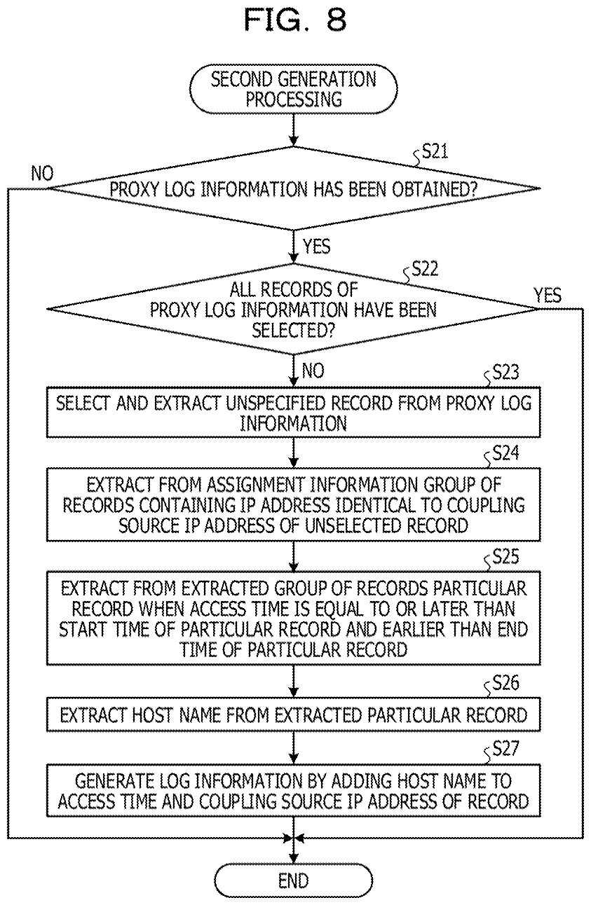

FIG. 8 is a flowchart illustrating an example of a processing operation of the second CPU 47 in the analysis server 7 in relation to second generation processing. In FIG. 8, the acquisition unit 61 of the second CPU 47 in the analysis server 7 determines whether the proxy log information 73 has been obtained from the proxy server 4 (step S21). When it is determined that the proxy log information 73 has been obtained (Yes in step S21), the extraction unit 62 of the second CPU 47 determines whether all records of the proxy log information 73 have been selected (step S22). A record of the proxy log information is proxy log information about an access from the client terminal 2.

When the extraction unit 62 determines that all records of the proxy log information 73 have not been selected (No in step S22), the extraction unit 62 extracts an unselected record from the proxy log information 73 (step S23). When the extraction unit 62 extracts an unselected record, the extraction unit 62 subsequently extracts from the assignment information 72 a group of records each containing a particular IP address identical to a coupling source IP address contained in the unselected record (step S24).

The extraction unit 62 further extracts, from the group of records extracted from the assignment information 72 in step S24, a particular record when an access time contained in the unselected record of the proxy log information 73 is equal to or later than the start time contained in the particular record and earlier than the end time of the particular record (step S25). The extraction unit 62 obtains a host name from the particular record extracted from the assignment information 72 (step S26). The generation unit 63 in the second CPU 47 generates the log information 74 by adding the obtained host name to the access time and the coupling source IP address contained in the unselected record of the proxy log information 73 (step S27); the processing operation illustrated in FIG. 8 consequently ends.

When the acquisition unit 61 determines that the proxy log information 73 has not been obtained (No in step S21), the processing operation illustrated in FIG. 8 ends. When the extraction unit 62 determines that all records of the proxy log information 73 have been selected (Yes in step S22), the processing operation illustrated in FIG. 8 ends.

The analysis server 7 that performs the second generation processing obtains the proxy log information 73 from the proxy server 4. The analysis server 7 extracts a host name from a particular record of the assignment information 72 in which a corresponding IP address is identical to the IP address contained in the obtained proxy log information 73 and a corresponding period for assigning the particular IP address involves the access time contained in the proxy log information 73. The analysis server 7 generates the log information 74 containing the obtained access time and coupling source IP address, and the extracted host name. As a result, the analysis server 7 is able to obtain the log information 74 in which an access time, a coupling source IP address and a host name are associated with each other.

The analysis server 7 of this embodiment extracts a host name from the assignment information 72 in which a corresponding IP address is identical to the obtained IP address and a corresponding period for assigning the IP address involves the obtained access time. The analysis server 7 accordingly generates the log information 74 containing the obtained access time and the extracted host name. As a result, it is possible to generate log information containing not only a time of access to the proxy server 4 but also the host name of the client terminal 2 that accesses the proxy server 4.

The analysis server 7 generates log information containing a coupling source IP address in addition to an access time and a host name. As a result, it is possible to identify a client terminal by using the access time, the coupling source IP address, and the host name that are associated with each other.

When the analysis server 7 refers to the generated log information 74 and detects an IP address in unauthorized communication, the analysis server 7 specifies a host name corresponding to the IP address in unauthorized communication. As a result, it is possible to identify a host name corresponding to an IP address in unauthorized communication.

The analysis server 7 obtains, periodically at predetermined times, IP addresses and access times of the client terminal 2 collected by the proxy server 4 in a predetermined period. As a result, the analysis server 7 is able to process, periodically at predetermined times, IP addresses and access times for a predetermined period.

It is noted that, for ease of description, an information processing apparatus is used as an example of the analysis server 7, but the configuration may be changed as appropriate, and for example, the analysis server 7 may be provided on the cloud. While the case in which the DHCP server 3 generates the assignment information 72 from the DHCP log information 71 is described as an example, the configuration may be changed as appropriate, and for example, the DHCP log information 71 may be transmitted to the analysis server 7 and the analysis server 7 may generate the assignment information 72 from the DHCP log information 71.

Furthermore, the components of parts illustrated in the drawings are not necessarily configured physically as illustrated in the drawings. This means that, for example, specific forms of dispersion and integration of the parts are not limited to those illustrated in the drawings, and all or part thereof may be configured by being functionally or physically dispersed or integrated in given units depending on various loads, the state of use, and the like.

Moreover, all or any of the various processing functions performed on the devices may be performed on a CPU (or a microcomputer, such as a microprocessor unit (MPU) or a microcontroller unit (MCU)). As might be expected, all or any of the various processing functions may be performed by a program analyzed and run by a CPU (or a microcomputer, such as an MPU or an MCU) or on a hardware device using a wired logic coupling.

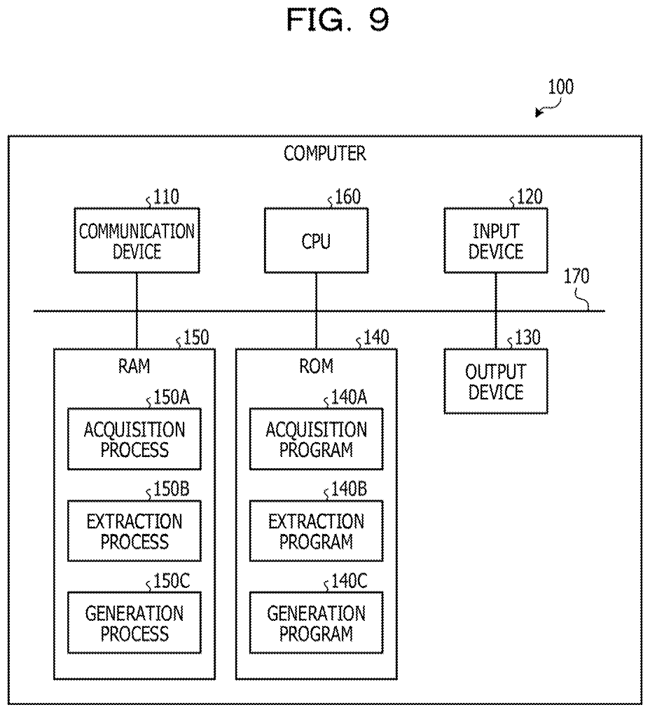

The various kinds of processing explained in the embodiments may be implemented by running a prepared log management program including a plurality of instructions on an information processing apparatus. Hereinafter, an example of a computer 100 that runs a log management program involving multiple instructions for implementing functions identical to the embodiments described above is described. FIG. 9 illustrates an example of the computer 100 that runs the log management program.

The computer 100 illustrated in FIG. 9 that runs the log management program includes a communication device 110, an input device 120, an output device 130, a ROM 140, a RAM 150, a CPU 160, and a bus 170.

The ROM 140 stores in advance the log management program for performing functions identical to the embodiments described above. The log management program may be recorded, instead of the ROM 140, on a recording medium readable by using a drive not illustrated in the drawing. As the recording medium, for example, a portable recording medium, such as a compact disc read-only memory (CD-ROM), a digital versatile disc (DVD), or a Universal Serial Bus (USB) flash drive, or a semiconductor memory, such as a secure digital (SD) card, may be used. As the log management program, an acquisition program 140A, an extraction program 140B, and a generation program 140C are used as illustrated in FIG. 9. The programs 140A to 140C may be combined or separated as appropriate.

The CPU 160 reads the programs 140A to 140C from the ROM 140 and loads the programs 140A to 140C into a work area on the RAM 150. The CPU 160 runs the programs 140A to 140C loaded into the RAM 150 as an acquisition process 150A, an extraction process 150B, and a generation process 150C as illustrated in FIG. 9.

The CPU 160 obtains from the first server a first address and a first access time of a first terminal device that accesses the first server. The CPU 160 obtains, from the second server that assigns an address to a terminal device, assignment information that is recorded separately in association with each of individual terminal devices and that contains an address assigned to a particular terminal device, an assignment period for which the address is assigned, and a host name of an assignee terminal device to which the address is assigned. The CPU 160 extracts a first host name contained in a particular record of assignment information in which a corresponding address is identical to the first address and a corresponding assignment period involves the first access time. The CPU 160 generates data containing at least the first access time and the first host name. As a result, it is possible to generate data containing the host name of a terminal that accesses the proxy server. [05] All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A log management system comprising:
one or more memories; and
one or more processors coupled to the one or more memories and the one or more processors configured to
in response to a first access of a first terminal device to a first server, acquire, from the first server, a first access time of the first access and a first address used by the first terminal device for the first access,
acquire, from a second server configured to assign one or more addresses to one or more terminal devices, assignment information including the one or more addresses assigned to the one or more terminal devices, one or more assignment periods for which the one or more addresses are assigned, and one or more host name of the one or more terminal devices to which the one or more addresses are assigned,
identify a first host name associated with the first address and the first access time in accordance with the assignment information, and
generate first log information indicating the first access associated with the first host name.

2. The log management system according to claim 1, wherein the first log information includes the first address and the first access time.

3. The log management system according to claim 1, wherein
the first server is a proxy server, and
the second server is a DHCP server.

4. The log management system according to claim 1, wherein the one or more processors are configured to, when an unauthorized communication is detected, extract a host name associated with an address relating to the unauthorized communication in accordance with the address relating to the unauthorized communication and the first log information.

5. The log management system according to claim 1, wherein the one or more processors are configured to periodically obtain, from the first server, an address which the terminal device has used for an access to the first server, and an access time of the access.

6. A computer-implemented log management method comprising:
in response to a first access of a first terminal device to a first server, acquiring, from the first server, a first access time of the first access and a first address used by the first terminal device for the first access;
acquiring, from a second server configured to assign one or more addresses to one or more terminal devices, assignment information including the one or more addresses assigned to the one or more terminal devices, one or more assignment periods for which the one or more addresses are assigned, and one or more host name of the one or more terminal devices to which the one or more addresses are assigned;
identifying a first host name associated with the first address and the first access time in accordance with the assignment information; and
generating first log information indicating the first access associated with the first host name.

7. The log management method according to claim 6, wherein the first log information includes the first address and the first access time.

8. The log management method according to claim 6, wherein
the first server is a proxy server, and
the second server is a DHCP server.

9. The log management method according to claim 6, further comprising:
when an unauthorized communication is detected, extracting a host name associated with an address relating to the unauthorized communication in accordance with the address relating to the unauthorized communication and the first log information.

10. The log management method according to claim 6, further comprising:
periodically acquiring, from the first server, an address used by the terminal device for an access to the first server, and an access time of the access.

11. A non-transitory computer-readable medium storing instructions executable by one or more computers, the instructions comprising:
one or more instructions for acquiring, from a first server, in response to a first access of a first terminal device to the first server, a first access time of the first access and a first address used by the first terminal device for the first access;
one or more instructions for acquiring, from a second server configured to assign one or more addresses to one or more terminal devices, assignment information including the one or more addresses assigned to the one or more terminal devices, one or more assignment periods for which the one or more addresses are assigned, and one or more host name of the one or more terminal devices to which the one or more addresses are assigned;
one or more instructions for identifying a first host name associated with the first address and the first access time in accordance with the assignment information; and
one or more instructions for generating first log information indicating the first access associated with the first host name.
